(19) United States
(12) Patent Application Publication
(10) Pub. No.: US 2006/0254137 A1
(43) Pub. Date: Nov. 16, 2006

(54) Support Device for Controlling and Protecting Plant Growth

(76) Inventor: Chang-lian Lin, San Jose, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/908,456

(22) Filed: May 12, 2005

(51) Int. Cl. A01G 13/02

(52) U.S. Cl. 47/32.4

(57) ABSTRACT

A support device and a method for its use with a plant for controlling and protecting plant growth. The device comprises a flexible band, a locking means, and a protective sheet. The method for use of the device comprises selecting a device of sufficient length to fit snuggly around the plant. The device is secured around the plant by the locking means. The locking means comprises engaging a flap into a perforation in the band. When the band is secured to the plant, the protective sheet can then be adjusted to lay between the plant and the perforations. The device may be adjustably secured around a plant, depending on the plant size, to hold the leaves and spikes of the plant in a generally vertical position. The device further provides protection for plants, allowing the plants to be densely packed together while in transit, thus maximizing the number of plants that can be transported safely.

### FIELD OF THE INVENTION

The present invention relates generally to the field of botany, and specifically to the field of plant husbandry. The invention is a device for controlling the growth of plants and potted plants and for protecting and orienting stalked growths, or spikes, upward, which is desirable to protect other plants, and for the growing of such plants generally.

### BACKGROUND ART

There are many plants existing that require the use of support devices or systems to aid in their growth. Plants commonly have leafy stalks such as flowers or spikes. It is desirable to grow the spikes straight up from the plant, however, they will often not grow this way unless supported or controlled. An old method by which this problem was solved was through the use of individual supports for the individual spikes. Each plant may have more than one spike, and thus a person would be required to find and attach a support such as a stake to each individual spike to encourage its straight growth. However, at least two problems were associated with this method. First, because numerous such plants were grown at a time, it was possible that the spike would not be noticed until it had already begun to grow in a crooked fashion, undesirably away from the center of the plant. Second, multiple individual stakes would have to be used for each plant, thus requiring individual attention for each spike, rather than each plant.

Many techniques have been used in the past for protecting plants and supporting their growth including the use of plant collars or plant sleeves. Such devices although useful in protecting the plant have several drawbacks. All of these devices are adapted for use with smaller-sized potted flowers or plants and are thus not adjustable to accommodate larger-sized plants. Many of these devices are also fitted for one time use only. Once the device is removed from the plant, it cannot be used again.

There is a need in the art, therefore, for a single, re-usable support device that can accommodate small to large sized plants. The prior art discloses the use of multiple stakes to facilitate the upward growth of a plant and the stalks. The prior approaches are primarily focused on providing support to the spikes after the spike has already sprouted and begun to grow in a crooked fashion.

Accordingly, it is a primary object of the invention to provide a support device for plants that can control the direction of plant growth and their spikes while simultaneously reducing the amount of time expended monitoring the growth of the plant and the time spent on each spike.

It is a further object to provide a support device that can be adjusted to accommodate different plant sizes and shapes.

It is a further object to provide a support device constructed from a transparent flexible material to allow light to penetrate the device without inhibiting growth.

It is a further object to provide a support device that prevents the leaves of the plant from sticking through the locking mechanism of the device.

It is a further object to provide a support device for densely packing plants in order to maximize the number of plants which can be transported per vehicle or container load.

It is a further object to provide a support device that prevents or minimizes inventory loss resulting from damage to the plants during transportation or when the plants are densely packed.

It is a further object to provide a support device that is re-usable.

It is a further object to provide a simple support device that does not require complicated equipment, tools, steps, or advanced technology to fabricate or use.

It is a further object to provide an improved method of controlling the growth of plants and their spikes.

Further objects of the invention will become apparent from the following description.

### SUMMARY OF THE INVENTION

The embodiments of the present invention solve the problems and address the drawbacks of the approaches in the above description. An embodiment of the present invention comprises a support device for controlling and protecting the growth of plant leaves and spikes. The device comprises a flexible band having two ends. The band is preferably transparent. The band is constructed from a flexible plastic or plastic-like material. A series of perforations are cut out from a first end of the band and a flap is cut out from a second end of the band. The device is fitted snuggly around the leaves and spikes of the plant to hold them in a generally vertical position. The device is secured around the plant by an adjustable locking means, forming a desired circumference around the plant. The locking means is comprised of engaging the flap into any one of the linear perforations. The device in its secured position has an opening at the top and bottom.

Another embodiment of the present invention includes a support device for plants that may be adapted to accommodate different size plants by adjusting the circumference of the device. Some plants are larger than others or are planted in larger pots than others. Adjusting the circumference of the device allows the user to exert control over the direction of the growth of the plant by increasing or decreasing the room the plant has to grow. The circumference is adjusted by engaging the flap with the best fit perforation so that the device fits snuggly around the plant.

An additional embodiment includes the incorporation of a protective sheet attached to the inner surface of the device between the plant and the perforations adapted for engaging the flap. The protective sheet prevents the leaves or spikes of the plant from sticking in the perforations. Since plants are leafy, it is desirable to have a sheet interposed between the plant and the locking part of the invention.

The present invention improves and maximizes the number of plants that can be transported safely while minimizing damage to the plants. The support device bunches the leaves and spikes together in an upward position, thus allowing for a dense packing of plants, resulting in higher transportation rates.

Still another embodiment of the present invention is a method of controlling and protecting the growth of plants and their spikes. A person need only attach one support device around each plant to assure the upward growth of all leaves and spikes, instead of using multiple stakes on each spike of the plant. Thus, the device increases the general quality output while decreasing the time associated with monitoring the plants, resulting in an increased efficiency of nursery operations.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 shows a basic structure of the device in an unlocked position, according of an embodiment of the present invention.

FIG. 2 shows the device in a locked position, according to an embodiment of the present invention.

FIG. 3 shows the device in a locked position and enclosed around a plant, according to an embodiment of the present invention.

### DETAILED DESCRIPTION

The description above and below and the drawings of the present document focus on one or more preferred embodiments of the present invention and also describe some exemplary optional features and/or alternative embodiments. The description and drawings are for the purpose of illustration and not limitation. Those of ordinary skill in the art will recognize variations, modifications, and alternatives. Such variations, modifications, and alternatives are also within the scope of the present invention. Section titles are terse and are for convenience only.

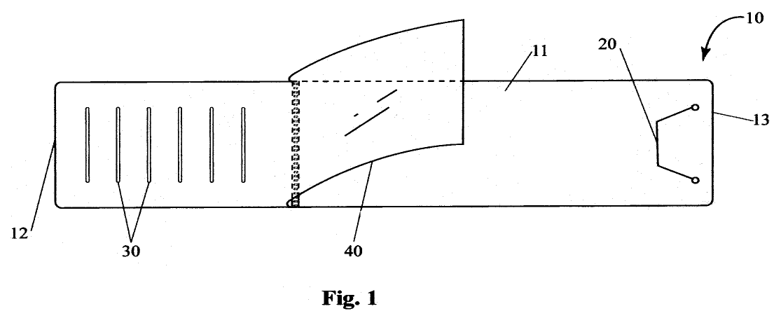

A preferred embodiment of the present invention includes a support device 10 for controlling the growth of plant spikes and protecting the plant as shown in FIG. 1. The device is comprised of a flexible band 11, a locking means, and a protective sheet 40. In an unlocked position, band 11 may have a generally rectangular shaped configuration. Band 11 may be constructed out of a sheet of transparent flexible plastic or plastic-like material of sufficient length to cover a circumference of a plant. Use of transparent material allows light to penetrate the device so as not to inhibit plant growth. Band 11 has a first end 12, a second end 13, an inside surface, and an outside surface. First end 12 comprises a plurality of perforations 30. Perforations 30 may have a linear configuration. Second end 13 includes a flap 20. Flap 20 may have a generally trapezoidal shaped configuration. Flap 20 is cut out on three sides with the remaining longest side attached to second end 13. A protective sheet 40 is attached to the inside surface of band 11. Protective sheet 40 has an inside edge and an outside edge. The inside edge is secured to the inside surface of band 11 at a position closer to first end 12. The outside edge is a free end, not attached to band 11.

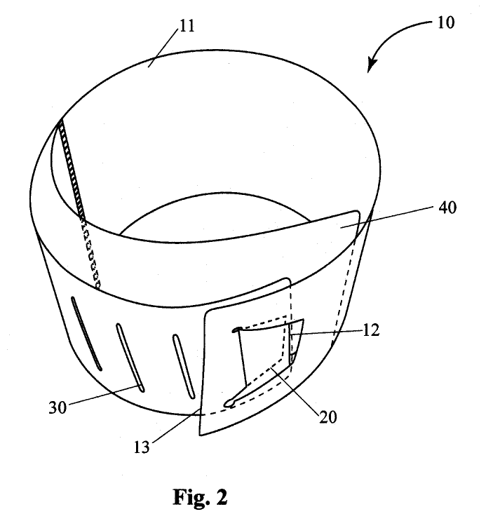

Referring now to FIG. 2 is an embodiment of the present invention wherein support device 10 is in a locked position. Support device 10 in the locked position has a cylindrical shaped configuration. Support device 10 has an opening at a top and at a bottom. Support device 10 is locked by the locking means. The locking means may comprise of engaging flap 20 into any one of perforations 30 from the outside surface.

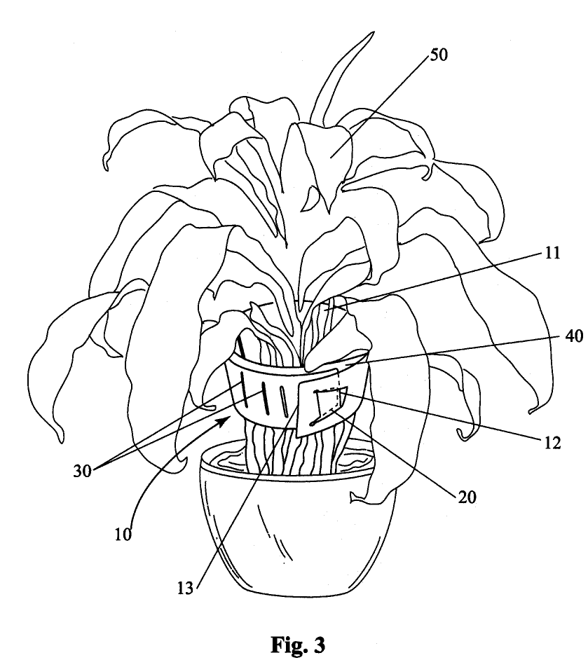

In FIG. 3, support device 10 is shown in use with a plant 50 and in the locked position. Support device 10 fits snuggly around the leaves and spikes of plant 50 holding plant leaves 50 in a generally vertical position to assure an upward growth. Support device 10 is secured around plant 50 by the locking means. Support device 10 may be easily adjusted to fit snuggly around a variety of plant types and sizes by engaging flap 20 with perforation 30 that best fits around plant 50. When support device 10 is in the locked position, protective sheet 40 covers flap 20 as well as perforations 30 to prevent the leaves or spikes of plant 50 from sticking through perforations 30.

A further embodiment of the present invention includes a method of controlling and protecting the growth of plants 50 and their spikes comprising selecting an appropriate sized support device 10 and securing support device 10 snuggly around plant 50. A person need only attach one support device 10 around plant 50, instead of using multiple stakes on each spike of plant 50. Thus increasing the general quality output while decreasing the time associated with monitoring plant 50, resulting in an increased efficiency of nursery operations.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

What is claimed is:

1. A plant support device for supporting and protecting a plant and plant growth comprising:
a flexible band having a first end and a second end, an inside surface and an outside surface;
a locking means for adjustably enclosing the band around the plant, the locking means comprising:
a generally trapezoidal shaped flap, the flap is a cut out on the second end with a longest side of the flap attached to the second end,
a plurality of perforations on the first end adapted for engaging with the flap; and
a protective sheet having an inside edge and an outside edge, the inside edge is vertically attached to the inside surface of the band at a position closer to the first end of the band, and the outside edge is a free end,
wherein the band encloses the plant growth and is secured by engaging the flap with any one of the perforations, the device in use is adapted for supporting plant growth in a generally vertical position.

2. The device of claim 1 wherein the band has a generally rectangular shape.

3. The device of claim 1 wherein the band is constructed from a plastic or a plastic-like material.

4. The device of claim 1 wherein the perforations are generally linear shaped.

5. The device of claim 1 wherein the protective sheet is made up of a transparent flexible material.

6. A method for using a plant support device of claim 1 for supporting and protecting a plant and plant growth comprising:
selecting a device of sufficient length to enclose the plant growth;
securing the device snuggly around the plant growth to cause plant growth in a generally vertical direction; and
adjusting the protective sheet to lay between the plant and the perforations.

7. The method of claim 6 wherein the band has a generally rectangular shape.

8. The method of claim 6 wherein the band is constructed from a plastic or a plastic-like material.

9. The method of claim 6 wherein the perforations are generally linear shaped.

10. The method of claim 6 wherein the protective sheet is made up of a transparent flexible material.

11. A plant support device for supporting and protecting a plant and plant growth comprising:
a flexible band constructed from a plastic or a plastic-like material, having a first end and a second end, an inside surface and an outside surface, the band having a generally rectangular shape;
a locking means for adjustably enclosing the band around the plant, the locking means comprising:
a generally trapezoidal shaped flap, the flap is a cut out on the second end with a longest side of the flap attached to the second end,
a plurality of perforations on the first end adapted for engaging with the flap, the perforations having a generally linear shape; and
a protective sheet made from a transparent flexible material, having an inside edge and an outside edge, the inside edge is vertically attached to the inside surface of the band at a position closer to the first end of the band and the outside edge is a free end,
wherein the band encloses the plant growth and is secured by engaging the flap with any one of the perforations, the device in use is adapted for supporting plant growth in a generally vertical position.
